(19) United States
(12) Patent Application Publication
(10) Pub. No.: US 2009/0229104 A1
(43) Pub. Date: Sep. 17, 2009

(54) TWO IN ONE VIDEO MONITOR MOUNT

(76) Inventor: Lawrence J. Beger, Chicago, IL (US)

Correspondence Address: CARDINAL LAW GROUP;Suite 2000, 1603 Orrington Avenue, Evanston, IL, 60201, US

(21) Appl. No.: 12/422,856

(22) Filed: Apr. 13, 2009

Related U.S. Application Data
(62) Division of application No. 11/534,961, filed on Sep. 25, 2006.

(51) Int. Cl. B23P 11/00

(52) U.S. Cl. 29/428

(57) ABSTRACT

A video monitor wall mount including components for switching between a fixed upright angle to an adjustable tilt angle configuration is disclosed. Also, a method for configuring a video monitor mount from a fixed upright angle to an adjustable tilt angle is disclosed. Also disclosed is a method for configuring a video monitor mount from an adjustable tilt angle to a fixed upright angle. Finally, a system for switching a video monitor wall mount configuration between a fixed upright angle and an adjustable tilt angle is disclosed.

### RELATED APPLICATIONS

This application claims the benefit of, and priority to, U.S. patent application Ser. No. 11/534,961 filed Sep. 25, 2006 as a divisional application, and incorporates the entirety of that application by reference.

The present invention generally relates to video monitor wall mounts. More specifically, the invention is directed to a wall mount that can be switched between a fixed upright angle and an adjustable tilt angle.

### BACKGROUND OF THE INVENTION

Current video monitor technology is moving rapidly to flat screens. LCD and plasma screens are popular flat screen products. These flat screens can be mounted in a traditional manner on a horizontal surface by placement on a stand. It is also now popular to mount flat screens on a wall. Video monitor wall mounts either have an adjustable tilt or a fixed position. Retailers use valuable shelf space to stock each type of product. Consumers are forced to choose one type of mount or the other before even using the product; whereas, consumers often do not decide what they prefer until after having a chance to try both configurations where they choose to install it. Consumers also sometimes change the location of their video monitors and would prefer to change the configuration of their wall mount once they relocate it.

Other problems with mounting flat screens onto a wall include making sure that the screen is level. Also, a cord or cords that are connected to the back of the flat screen monitor can give a messy appearance. Further, rotating support arms can be “sticky” and prevent easy rotation of the mounted monitor. Finally, the installation process itself can be difficult or frustrating. An installer may never know if the mount is actually properly placed together. Improperly assembled mounts can be less stable than properly assembled mounts.

It is an object of this invention, therefore, to overcome the deficiencies and obstacles described above.

### SUMMARY OF THE INVENTION

One aspect of the present invention provides a method for configuring a video monitor mount from a fixed upright angle to an adjustable tilt angle, the method includes releasing a first monitor attachment and a second monitor attachment from a wall mount, the wall mount including a mating lip with a top edge and a bottom edge, the first monitor attachment including a first bar receiver opening and the second monitor attachment including a second bar receiver opening. The method further includes receiving a support bar in the first bar receiver opening and the second bar receiver opening, the support bar including a first end portion and a second end portion. The method further includes receiving the first end portion and the second end portion of the support bar in a first cradle portion and second cradle portion of the wall mount.

Another aspect of the invention provides a method for configuring a video monitor mount from an adjustable tilt angle to a fixed upright angle, the method includes releasing a first monitor attachment and a second monitor attachment from a wall mount, the first monitor attachment including a first bar receiver opening and a mating groove and the second monitor attachment including a second bar receiver opening and a mating groove, the wall mount including a mating lip with a top edge and a bottom edge. The method further includes releasing a support bar from the first bar receiver opening and the second bar receiver opening, the support bar including a first end portion and a second end portion. The method further includes releasing the end portions of the support bar in a first and second cradle portion of the wall mount. The method further includes mating the groove of each first monitor attachment and the second monitor attachment to the mating lip of the wall mount. The method further includes clasping the mating lip inside the groove of each the first and second monitor attachment.

Another aspect of the invention provides a method for configuring a video monitor mount, the method includes removing a first monitor attachment and a second monitor attachment from a wall mount, where the first monitor attachment includes a first bar receiver opening and a mating groove and where the second monitor attachment includes a second bar receiver opening and a mating groove, the wall mount including a mating lip with a top edge and a bottom edge. The method further includes removing a support bar from the first bar receiver opening and the second bar receiver opening, the support bar including a first end portion and a second end portion. The method further includes removing the end portions of the support bar from a first and second cradle portion of the wall mount. The method further includes inserting the groove of each the first monitor attachment and the second monitor attachment over the mating lip of the wall mount. The method further includes locking the mating lip inside the groove of each the first and second monitor attachment.

Another aspect of the invention provides a video monitor mount, including a wall mount, the wall mount including a mating lip with a top edge and a bottom edge. The video monitor mount further includes a first monitor attachment and a second monitor attachment, at least one of the first monitor attachment and second monitor attachment including a mating groove to mate with the mating lip. The video monitor mount further includes a first releasable lock lever attached to the first monitor attachment. The video monitor mount further includes a second releasable lock lever attached to the second monitor attachment.

Another aspect of the invention provides a system for switching a video monitor wall mount configuration between a fixed upright angle and an adjustable tilt angle. The system includes means for releasing a first monitor attachment and a second monitor attachment from a wall mount. The system further includes means for attaching a first monitor attachment and a second monitor attachment to a wall mount in a fixed upright angle. The system further includes means for attaching a first monitor attachment and a second monitor attachment to a wall mount in an adjustable tilt angle. The system further includes means for detaching a first releasable lock lever from the first monitor attachment, the first lock lever attached to the first monitor attachment mating to a bottom edge of a wall mount lip. The system further includes means for detaching a second releasable lock lever from the second monitor attachment, the second lock lever attached to the second monitor attachment abuts mating to the bottom edge of the wall mount lip. The system further includes means for disengaging a groove of each the first monitor attachment and the second monitor attachment from a mating lip of the wall mount. The system further includes means for mating the groove of each first monitor attachment and the second monitor attachment to the mating lip of the wall mount. The system further includes means for clasping the mating lip inside the groove of each the first and second monitor attachment.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 illustrates one embodiment of a system for switching a video monitor wall mount configuration between a fixed upright angle and an adjustable tilt angle in accordance with one aspect of the invention;

FIG. 2 illustrates one embodiment of a method for changing a video monitor mount configuration from a fixed upright angle to an adjustable tilt angle in accordance with one aspect of the invention;

FIG. 3 illustrates one embodiment of a method for releasing the monitor attachments from the wall mount in accordance with one aspect of the invention;

FIG. 4 illustrates one embodiment of a method for changing a video monitor mount configuration from a fixed upright angle to an adjustable tilt angle in accordance with one aspect of the invention;

FIG. 5 illustrates one embodiment of a method for changing a video monitor mount configuration from a fixed upright angle to an adjustable tilt angle in accordance with one aspect of the invention;

FIG. 6 illustrates one embodiment of a method for changing a video monitor mount configuration from a fixed upright angle to an adjustable tilt angle in accordance with one aspect of the invention;

FIG. 7 illustrates one embodiment of a method for changing a video monitor mount configuration from a fixed upright angle to an adjustable tilt angle in accordance with one aspect of the invention;

FIG. 8 illustrates one embodiment of a method for changing a video monitor mount configuration from an adjustable tilt angle to a fixed upright angle in accordance with one aspect of the invention;

FIG. 9 illustrates one embodiment of a method for releasing detachable braces from the cradle portions in accordance with one aspect of the invention;

FIG. 10 illustrates one embodiment of a method for attaching lock levers to the monitor attachments to mate with the bottom edge of the mating lip in accordance with one aspect of the invention;

FIG. 11 illustrates one embodiment of a method for changing a video monitor mount configuration from an adjustable tilt angle to a fixed upright angle in accordance with one aspect of the invention;

FIG. 12 illustrates one embodiment of a method for changing a video monitor mount configuration from an adjustable tilt angle to a fixed upright angle in accordance with one aspect of the invention;

FIG. 13 illustrates one embodiment of a method for changing a video monitor mount configuration from an adjustable tilt angle to a fixed upright angle in accordance with one aspect of the invention;

FIG. 14 illustrates one embodiment of a method for removing detachable braces from the wall mount cradle portions in accordance with one aspect of the invention;

FIG. 15 illustrates one embodiment of a method for fastening the lock levers to the monitor attachments to mate with the bottom edge of the mating lip in accordance with one aspect of the invention;

FIG. 16 illustrates one embodiment of a method for changing a video monitor mount configuration from an adjustable tilt angle to a fixed upright angle in accordance with one aspect of the invention;

FIG. 17 illustrates a perspective view for an adjustable tilt angle configuration in accordance with one aspect of the invention;

FIG. 18 illustrates a side view for an adjustable tilt angle configuration in accordance with one aspect of the invention;

FIG. 19 illustrates a side view for an adjustable tilt angle configuration in accordance with one aspect of the invention;

FIG. 20 illustrates a side view for an adjustable tilt angle configuration in accordance with one aspect of the invention;

FIG. 21 illustrates a perspective view for a fixed upright angle configuration in accordance with one aspect of the invention;

FIG. 22 illustrates one embodiment for a locking lever for a fixed upright mount configuration in accordance with one aspect of the invention;

FIG. 23 illustrates a side view for an fixed upright angle configuration in accordance with one aspect of the invention;

FIG. 24 illustrates a side view for an adjustable tilt angle configuration showing the various axis and planes in accordance with one aspect of the invention;

FIG. 25 illustrates a magnified side view for an adjustable tilt angle configuration showing the groove axis and lip plane in accordance with one aspect of the invention when the tilt angle is approximately zero degrees; and

FIG. 26 illustrates a side view for an adjustable tilt angle configuration showing the groove axis and lip plane in accordance with one aspect of the invention when the tilt angle is approximately twenty degrees.

### DETAILED DESCRIPTION OF THE

### Preferred Embodiments

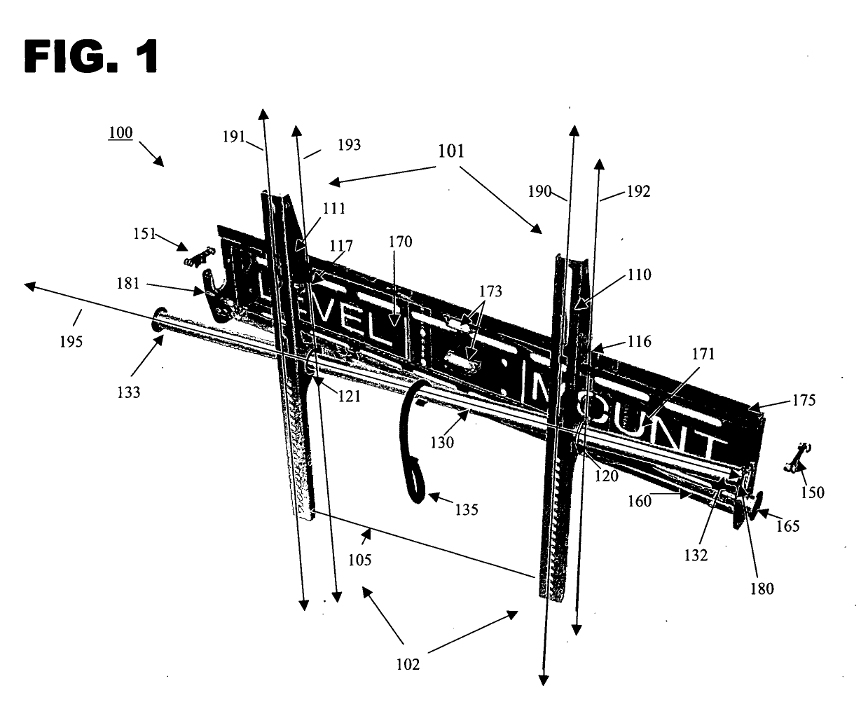

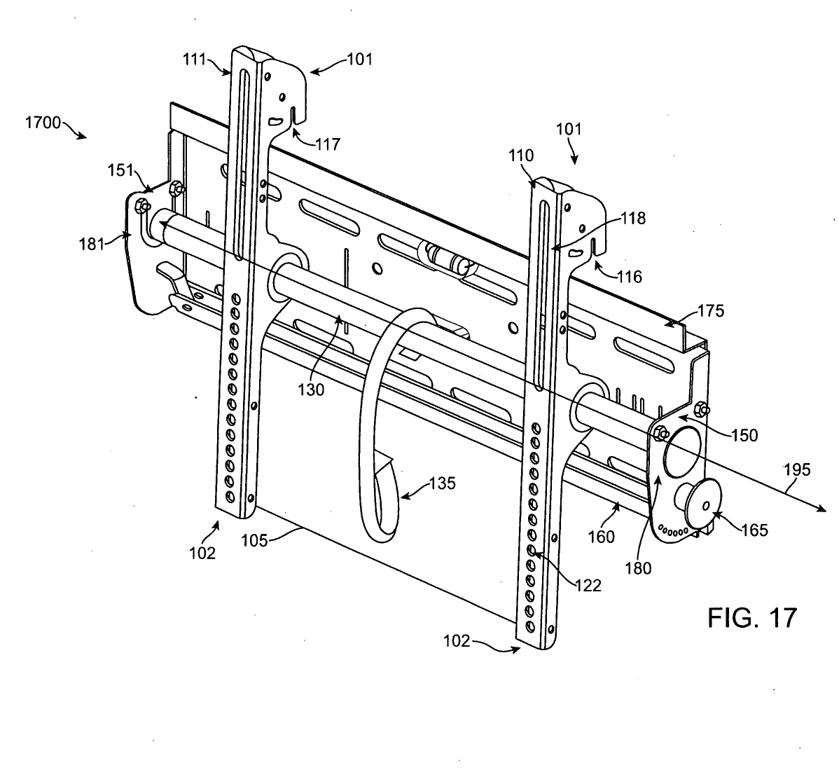

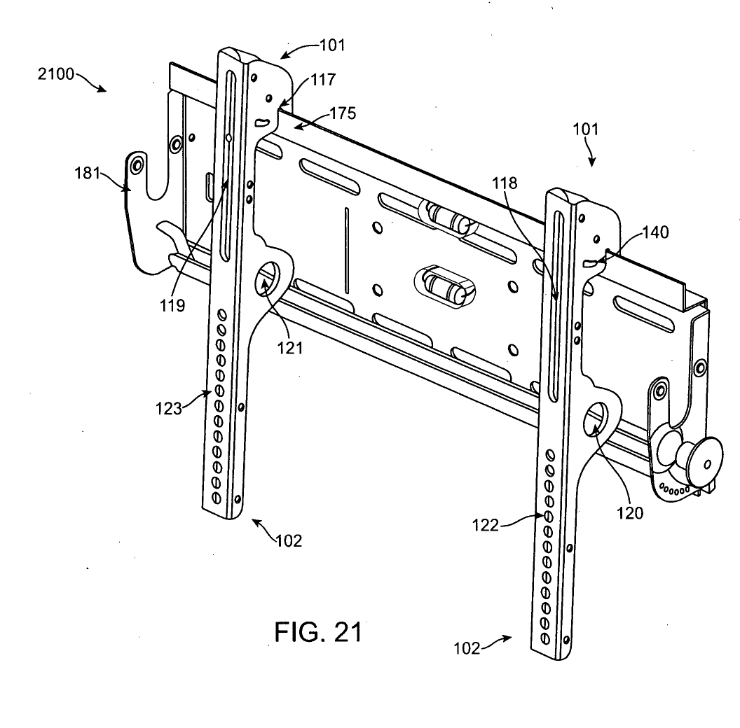

FIG. 1 illustrates a system 100 for switching a video monitor wall mount between an adjustable tilt angle 1700 (see FIG. 17) and a fixed upright angle 2100 (see FIG. 21), in accordance with one aspect of the invention. In one embodiment, system 100 includes at least two monitor attachments, such as first monitor attachment 110 and second monitor attachment 111. Additionally, system 100 includes a wall mount 170. Wall mount 170 includes a mating lip 175, a bubble level 190, and first cradle portion 180 and second cradle portion 181 on opposing sides of wall mount 170. System 100 further includes a support bar 130. In one embodiment, system 100 further includes a cord management strap 135, at least two detachable braces 150, 151, a tilt bar 160 with a tilt knob 165. Monitor attachments 110, 111 are equipped with suitable hardware to be fastened to a video monitor. Wall mount 170 is equipped with suitable hardware to be fastened to a wall.

In the adjustable tilt configuration 1700 (see FIG. 17), system 100 provides for adjusting the tilt angle of the monitor attachments 110, 111 by movement of the tilt knob 165. In the fixed upright configuration 2100 (see FIG. 21), system 100 is fixed upright obstructing any movement to the tilt angle 167 of the monitor attachments 110, 111.

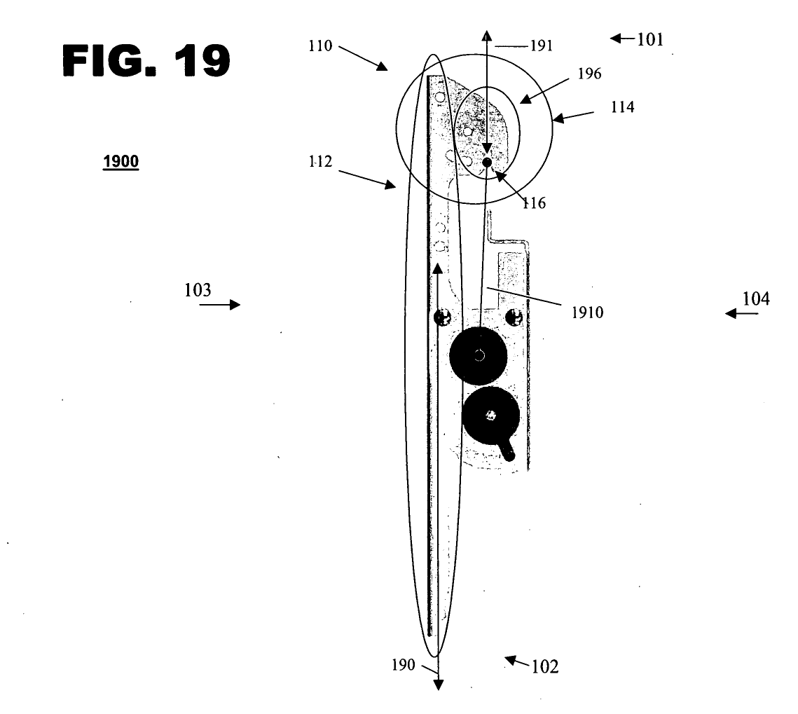

Monitor attachments 110, 111 are equipped with suitable hardware to be fastened to the backside of a video monitor at an adjustable width 105 from one another. The first monitor attachment 110 includes a vertical leg 112 (see FIG. 19) defining a leg axis 190 the vertical leg 112 including an upper portion 114 (see FIG. 19) including a groove portion, the groove portion including groove 116, the groove defining a groove axis 192 parallel to the leg axis 190. The vertical leg 112 includes a channel 118 (see FIG. 21) on the top half and a series of screw holes 122 (see FIG. 21) on the bottom half for fastening the first monitor attachment to the back of a video monitor. The first monitor attachment 110 includes a groove 116 on each side that fits onto mating lip 175 of the wall mount 170. The first monitor attachment 110 includes an enclosed circular opening, termed the bar receiver opening 120 through which support bar 130 fits for insertion and removal. Suitable hardware includes, but is not limited to screws, nuts, bolts, and the like.

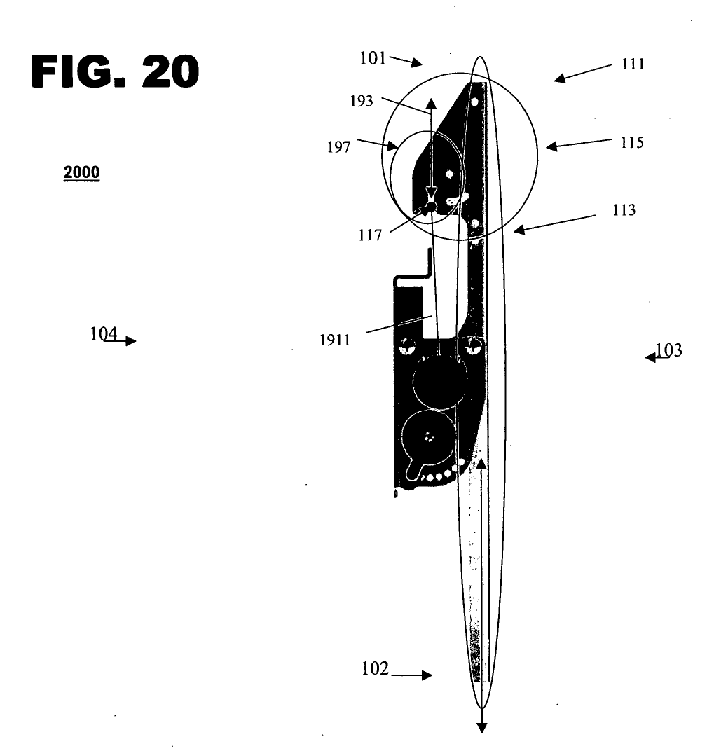

The second monitor attachment 111 includes a vertical leg 113 (see FIG. 20) defining a leg axis 191. Vertical leg 113 includes an upper portion 115 (FIG. 20) including a groove portion, the groove portion including groove 117. Groove 117 defines a groove axis 193 extending substantially parallel to the leg axis 191. The vertical leg 113 (see FIG. 20) includes a channel 119 (see FIG. 21) on the top half and a series of screw holes 123 (see FIG. 21) on the bottom half for fastening the first monitor attachment to the back of a video monitor (not shown). The second monitor attachment 111 includes a groove 117 on each side that fits onto mating lip 175 of the wall mount 170. The second monitor attachment 111 includes an enclosed circular opening, bar receiver opening 121 through which support bar 130 fits for insertion and removal.

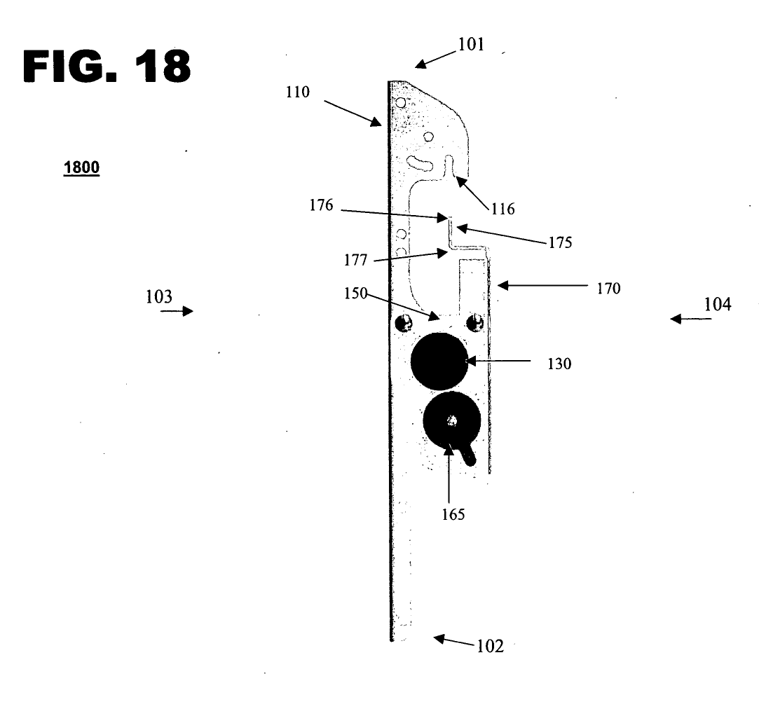

Wall mount 170 is configured to attach to a vertical surface, such as a w11, with suitable hardware. Wall mount 170 includes a mating lip 175 that fits into and mates with grooves 116, 117. Mating lip 175 includes a top edge 176 and a bottom edge 177 (see FIG. 18). In one embodiment, wall mount 170 also includes cradle portions 180, 181 to hold support bar 130. Wall mount 170 includes at least one bubble level 173. In one embodiment, wall mount 170 includes at least one engraved icon 171 indicative of an origin of the wall mount, the engraved icon extending through the wall mount.

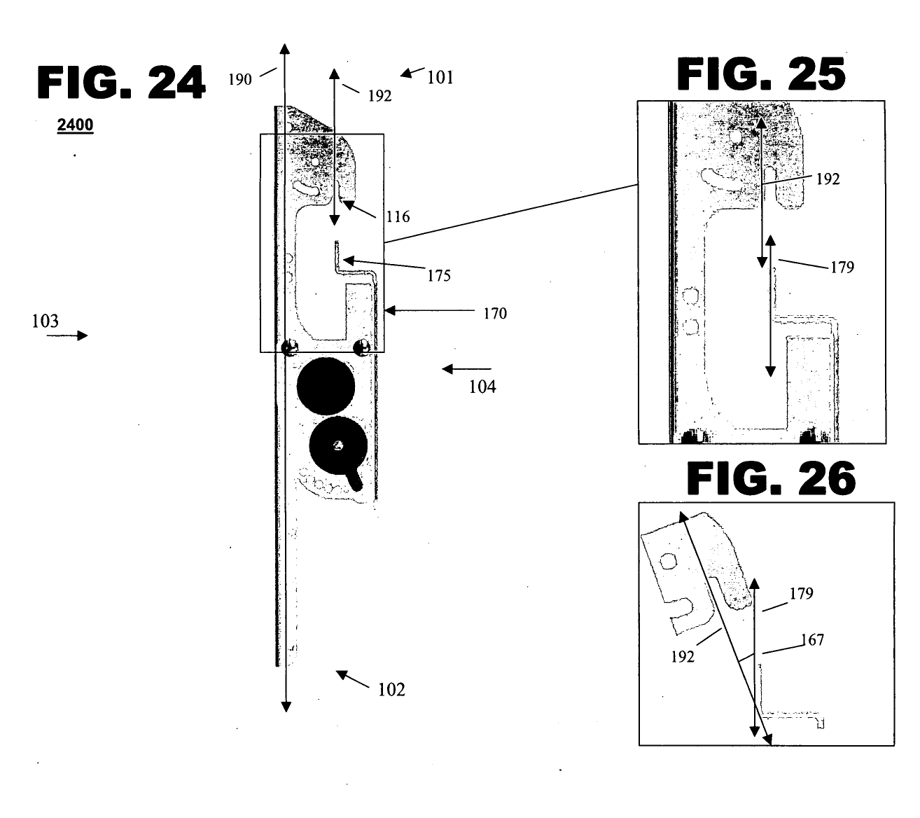

Support bar 130 joins monitor attachments 110, 111 to wall mount 175 in the adjustable tilt configuration 1700. The bar receiver openings 120, 121 of the monitor attachments fit around the support bar 130. The support bar 130 includes a first end portion 132 and a second end portion 133. The first end portion 132 is held in a first cradle portion 180, and is free to rotate in response to the movement of tilt bar 160. The second end portion 133 is held in a second cradle portion 181, and is free to rotate in response to the movement of tilt bar 160. The support bar is secured in the cradle portions 180, 181 by detachable braces 150, 151 that lock on top of each cradle 180, 181 and circumscribe the support bar 130. The top opening of the first cradle portion refers to the opening opposite of a bottom of the cradle portion. The top is located between a support bar axis and the wall mount lip. The support bar 130 also includes a cord management strap 135 adapted to organize and retain the cords that feed into and out of the back of the monitor. The support bar 130 rotates around a support bar axis 195 for the adjustable tilt angle configuration 1700 when a pressure input is applied to the first monitor attachment 110 or the second monitor attachment 111, the support bar axis runs substantially parallel to the lip plane 179 (see FIG. 24) and substantially perpendicular to the leg axis 190 of the first monitor attachment 110 and substantially perpendicular to the leg axis 191 of the second monitor attachment 111. The support bar 130 is removed from system 100 for the fixed upright configuration 2100.

The first detachable brace 150 attaches on top of cradle portion 180 in the adjustable tilt configuration 1700 where the brace and the cradle attached together circumscribes the first end portion of the support bar 130. In one embodiment, the detachable brace 150 locks on top of the cradle 180 with screws and nuts. Detachable brace 150 is removed from system 100 for the fixed upright configuration 2100.

The second detachable brace 151 attaches on top of cradle portion 181 in the adjustable tilt configuration 1700 where the brace and the cradle attached together circumscribes the first end portion of the support bar 130. In one embodiment, the detachable brace 151 locks on top of the cradle 181 with screws and nuts. Detachable brace 151 is removed from system 100 for the fixed upright configuration 2100.

The tilt bar 160 rotates in response to a rotation input from tilt knob 165. The tilt bar 160 operatively connects to the monitor attachments 110, 111. A rotation input to tilt knob 165 rotates tilt bar 160 and alters the title angle of the first and second monitor attachments. The tilt bar 150 and tilt knob 165 are operatively attached to the cradle portion 180, 181 of the wall mount 170. Rotation of knob 165 will turn the tilt bar 160 clockwise or counterclockwise in relation to the support bar axis 195.

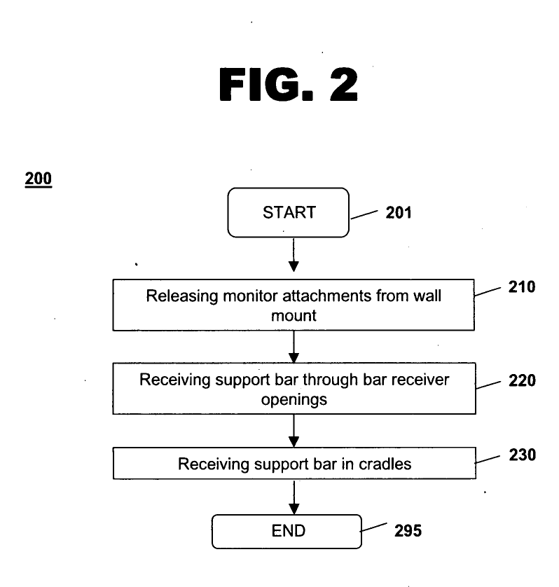

FIG. 2 illustrates one embodiment of a method 200 for changing a video monitor mount configuration from a fixed upright angle 2100 (see FIG. 21) to an adjustable tilt angle 1700 (see FIG. 17), in accordance with one aspect of the invention. The support bar is inserted through the monitor attachments and joined to the wall mount. Method 200 begins at 201.

At step 210, a first monitor attachment 110 and a second monitor attachment 111 release from a wall mount 170. Prior to release, the monitor attachments were fastened to the wall mount 170. At step 210, the monitor attachments 110, 111 are released and separated from the wall mount 170.

At step 220, the bar receiver openings 120, 121 on the monitor attachments receive the support bar. In one embodiment, the circumference of the support bar 130 fits snug in the bar receiver openings 120, 121.

At step 230, the first cradle portion 180 of the wall mount receives the first end portion 132 of the support bar, and the second cradle portion 181 of the wall mount receives the second end portion 133 of the support bar.

Method 200 ends at step 295.

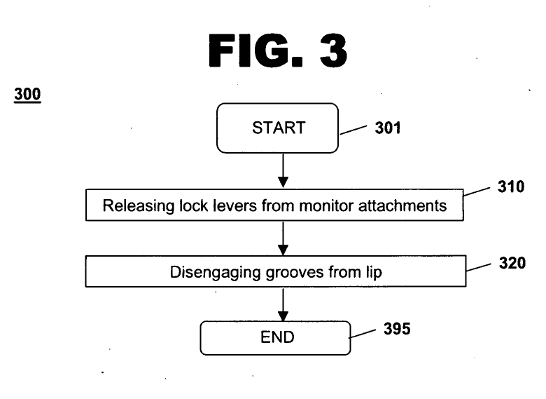

FIG. 3 illustrates one embodiment of a method for releasing the monitor attachments 110, 111 from the wall mount 170, in accordance with one aspect of the invention. Method 300 begins at 301.

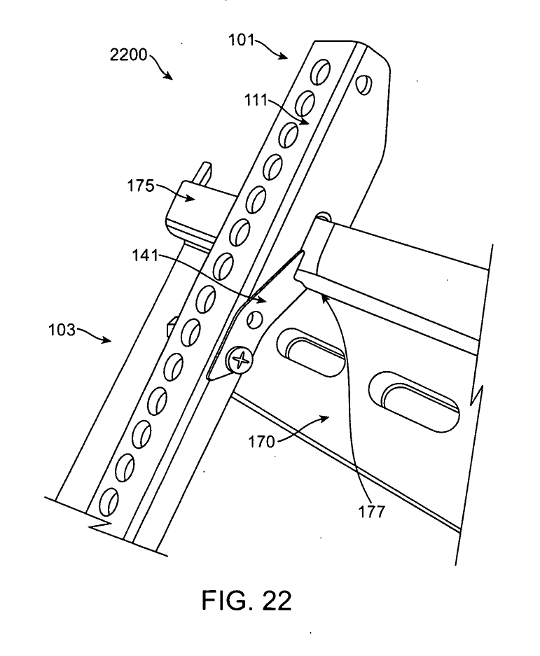

At step 310, a first lock lever 140 releases from the first monitor attachment 110, and a second lock lever 141 releases from the second monitor attachment 111. Each lock lever 140, 141 (see FIG. 22) mates to the bottom edge 177 (see FIG. 18) of the wall mount lip prior to release.

At step 320, the groove 116 of the first monitor attachment 110 and the groove 117 of the second monitor attachment 111 disengage from the mating lip 175.

Method 300 ends at step 395.

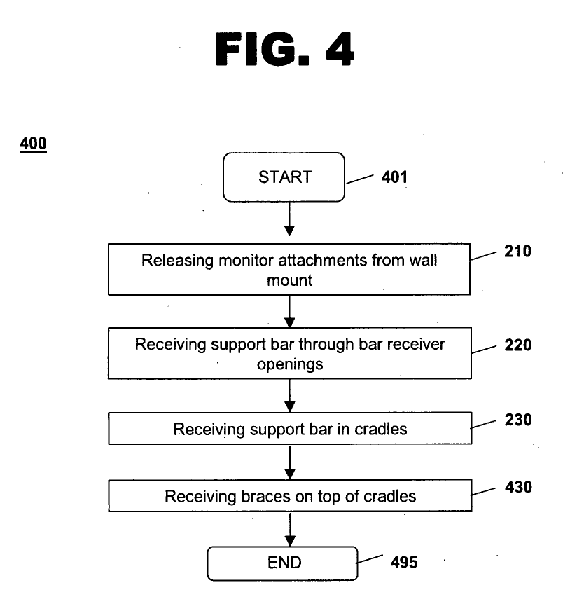

FIG. 4 illustrates one embodiment of a method 400 for changing a video monitor mount configuration 170 from a fixed upright angle 2100 to an adjustable tilt angle 1700, in accordance with one aspect of the invention. Method 400 begins at step 401.

Method 400 includes steps 210-230 of method 200, with the additional step of receiving braces 150, 151 on top of the cradles at step 430. The first cradle portion 180 receives the first detachable brace 150 to cover the opening on top of the cradle. By closing the opening, the detachable brace 150 attached to the cradle portion 180 completely circumscribes the support bar end portion 132. The second cradle portion 181 receives the second detachable brace 151 to cover the opening on top of the cradle. By closing the opening, the detachable brace 151 attached to the cradle portion 181 completely circumscribes the support bar end portion 133.

Method 400 ends at step 495.

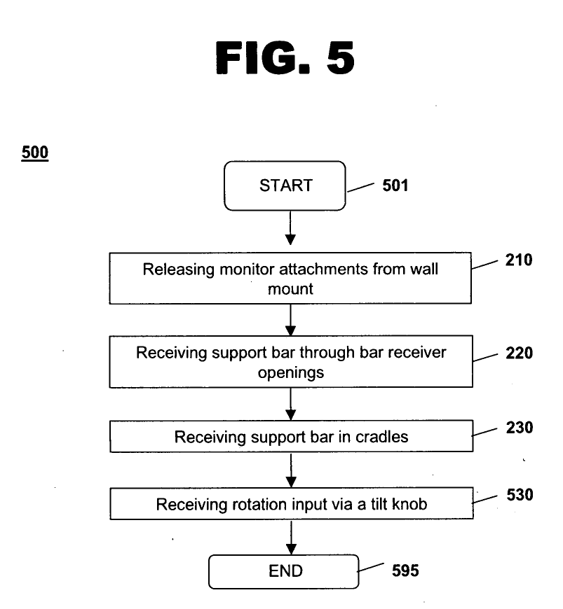

FIG. 5 illustrates one embodiment of a method 500 for changing a video monitor mount configuration from a fixed upright mount to an adjustable tilt mount, in accordance with one aspect of the invention. Method 500 begins at step 501.

Method 500 includes the steps 210-230 from method 200, with the additional step of receiving a rotation input via a tilt knob 165 in communication with a tilt bar 160 at step 530. The tilt bar 160 is operatively connected to the monitor attachments 110, 111. The knob 165 will turn the tilt bar 160 in such degrees as to rotate the monitor attachments clockwise, or counterclockwise in relation to the support bar axis 195.

Method 500 ends at step 595.

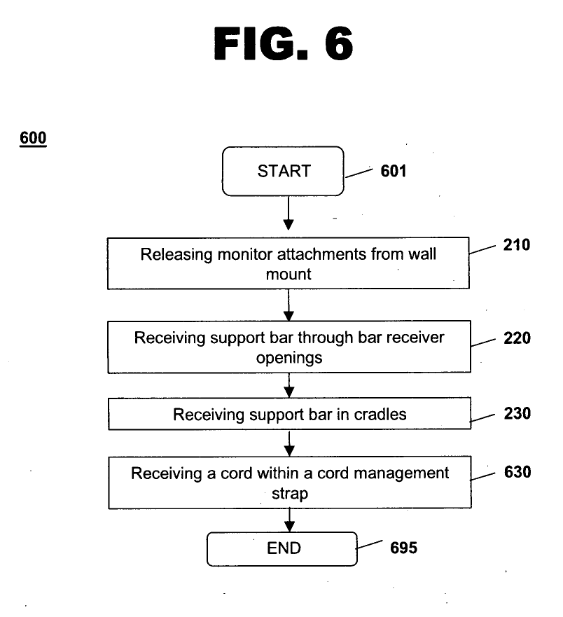

FIG. 6 illustrates one embodiment of a method 600 for changing a video monitor mount configuration from a fixed upright angle to an adjustable tilt angle, in accordance with one aspect of the invention. Method 600 begins at step 601.

Method 600 includes steps 210-230 from method 200, with the additional step of receiving a cord within a cord management strap 135 at step 630. The cord management strap 135 organizes and retains the cords that feed into and out of the back of a monitor. Cord management strap 135 can include any appropriate shape, such as a hook, a channel, a latch, or other shapes. In addition, cord management strap 135 includes an open edge to allow insertion and/or removal of cords in on embodiment. In another embodiment, cord management strap 135 includes a closed surface such that cords are inserted through a gap defined by cord management strap 135. In yet another embodiment, cord management strap 135 includes a latch to open and close to securely grasp a plurality of cords while simultaneously, the cords can be easily removed by opening the latch.

Method 600 ends at step 695.

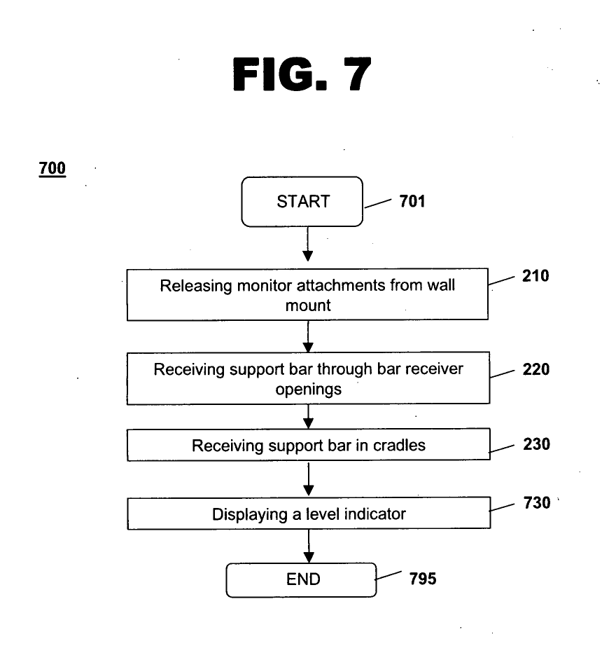

FIG. 7 illustrates one embodiment of a method 700 for changing a video monitor mount configuration from a fixed upright angle to an adjustable tilt angle, in accordance with one aspect of the invention. Method 700 begins at step 701.

Method 700 includes steps 210-230 from method 200, with the additional step of displaying a level indicator 173 at step 730. The level indicator 173 is displayed via at least one bubble level attached to the wall mount 170 to level the placement of the wall mount 170 on a wall.

Method 700 ends at step 795.

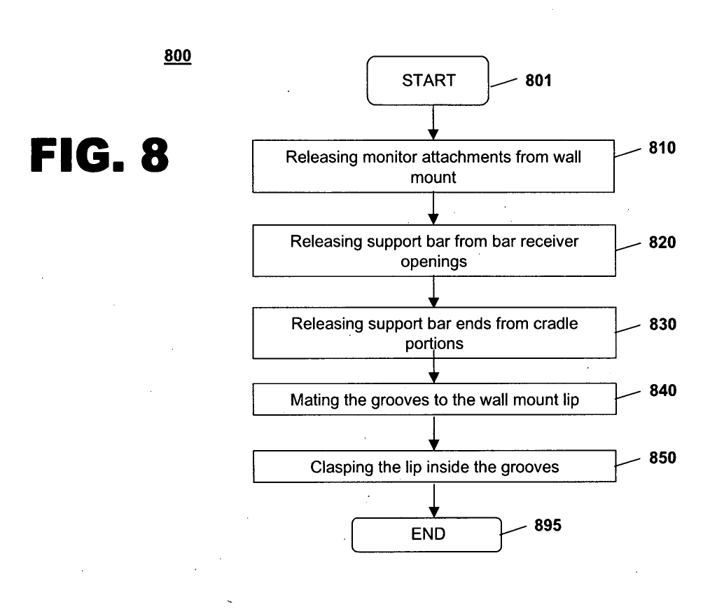

FIG. 8 illustrates one embodiment of a method 800 for changing a video monitor mount configuration from an adjustable tilt angle 1700 to a fixed upright angle 2100, in accordance with one aspect of the invention. Method 800 begins at 801.

At step 810, a first monitor attachment 110 and a second monitor attachment 111 release from wall mount 170. Prior to release the monitor attachments 110, 111 were fastened to the wall mount 170.

At step 820, the bar receiver openings 120, 121 on the monitor attachments release the support bar. In one embodiment, the support bar slides out from the bar receiver openings 120, 121 on the monitor attachments At step 830, the first cradle portion 180 of the wall mount release the first end portion 132 of the support bar, and the second cradle portion 181 of the wall mount releases the second end portion 133 of the support bar 130.

At step 840, the grooves 116 of monitor attachment 110 and the grooves 117 of monitor attachment 111 mate to the mating lip 175 of the wall mount 170. Mating lip 175 fits into grooves 116, 117.

At step 850, mating lip 175 clasps inside the grooves 116, 117 of the first monitor attachment 110 and the second monitor attachment 111.

Method 800 ends at step 895.

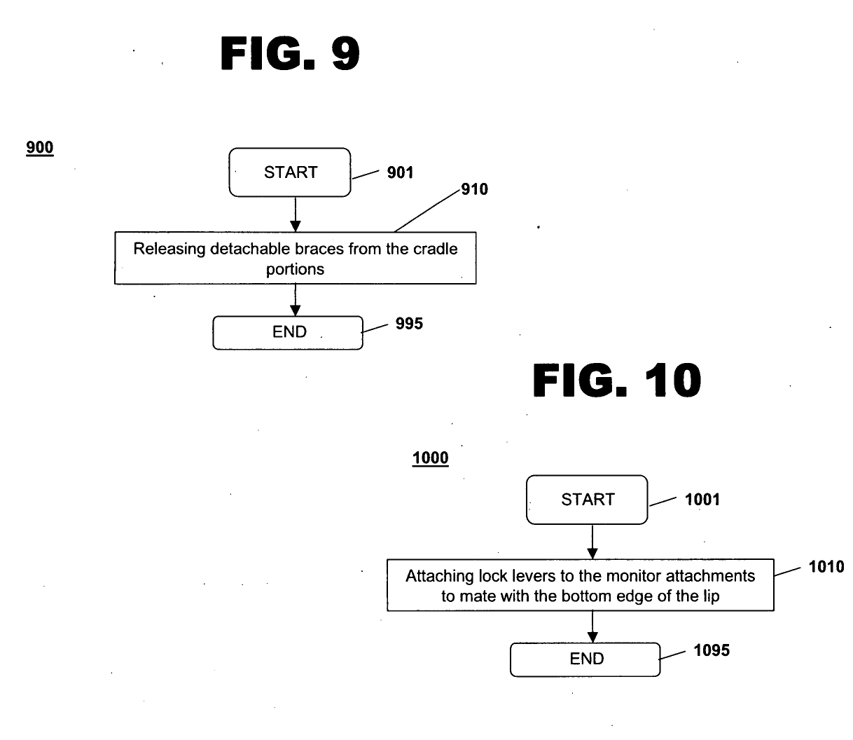

FIG. 9 illustrates one embodiment of a method 900 for releasing detachable braces 150, 151 from the first and second cradle portions 180, 181, in accordance with one aspect of the invention. Method 900 begins at step 901.

At step 910, the first detachable brace 150 releases from the first cradle portion 180. Also at step 910, the second detachable brace 151 releases from the second cradle portion 181.

Method 900 ends at step 995.

FIG. 10 illustrates one embodiment of a method 1000 for attaching lock levers 140, 141 to the monitor attachments 110, 111 to mate with the bottom edge 177 of the mating lip 170, in accordance with one aspect of the invention. Method 1000 begins at step 1001.

At step 1010, the first releasable lock lever 140 attaches to the first monitor attachment 110. Also at step 1010, the second releasable lock lever 141 attaches to the second monitor attachment 111.

Method 1000 ends at step 1095.

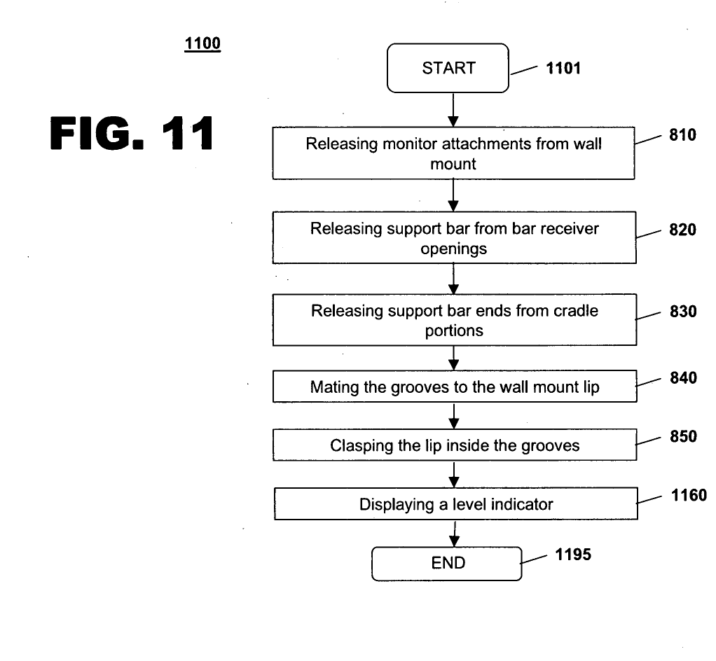

FIG. 11 illustrates one embodiment of a method 1100 for changing a video monitor mount configuration from an adjustable tilt angle to a fixed upright angle, in accordance with one aspect of the invention. Method 1100 begins at step 1101.

Method 1100 includes the steps 810-850 from method 800, with the additional step of displaying a level indicator 173 at step 1160. The level indicator 173 is displayed via at least one bubble level attached to the wall mount 170 to level the placement of the wall mount 170 on a wall.

Method 1100 ends at step 11195.

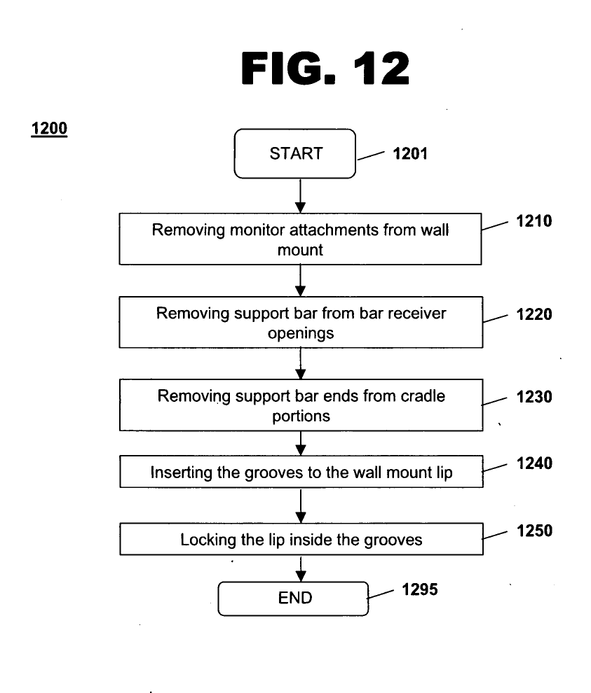

FIG. 12 illustrates one embodiment of a method 1200 for changing a video monitor mount configuration from an adjustable tilt angle 1700 to a fixed upright angle 2100, in accordance with one aspect of the invention. Method 1200 begins at 1201.

At step 1210, a first monitor attachment 110 and a second monitor attachment 111 are removed from wall mount 170. Prior to removal the monitor attachments were fastened to the wall mount 170. At step 1210 the monitor attachments 110, 111 are removed and separated from the wall mount 170.

At step 1220, the support bar is removed from the bar receiver openings 120, 121. The support bar 130 can be slid out of bar receiver openings 120, 121.

At step 1230, the first end portion 132 of the support bar is removed from the first cradle portion 180 of the wall mount, and the second end portion 133 of the support bar 130 is removed from the second cradle portion 181 of the wall mount.

At step 1240, the grooves 116 of monitor attachment 110 and the grooves 117 of monitor attachment 111 are inserted into the mating lip 175 of the wall mount 170.

At step 1250, lip 175 locks inside the grooves 116, 117 of the first monitor attachment 110 and the second monitor attachment 111.

Method 1200 ends at step 1295.

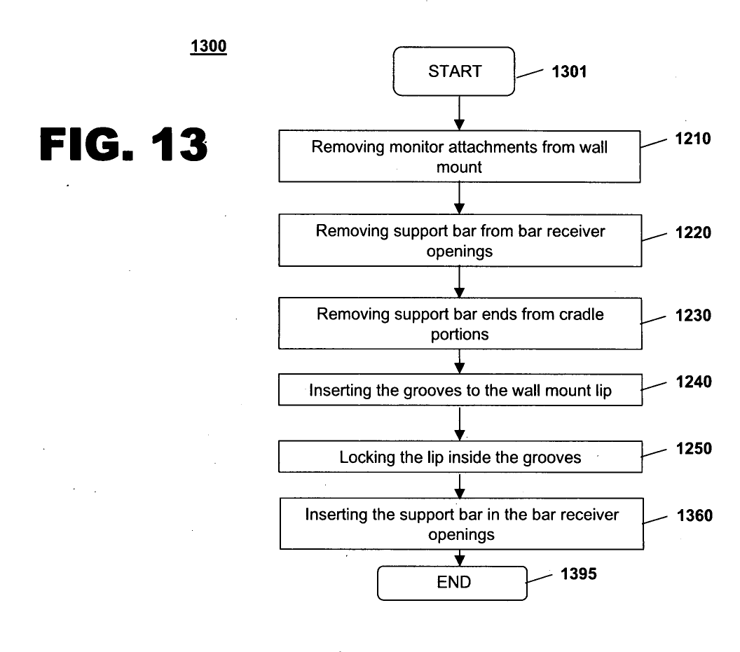

FIG. 13 illustrates one embodiment of a method 1300 for changing a video monitor mount configuration from an adjustable tilt angle to a fixed upright angle, in accordance with one aspect of the invention. Method 1300 begins at 1301.

Method 1300 includes the same steps from method 1200, with the additional step of inserting the support bar 130 in the bar receiver openings 120, 121 at step 1360. Method 1300 ends at step 1395.

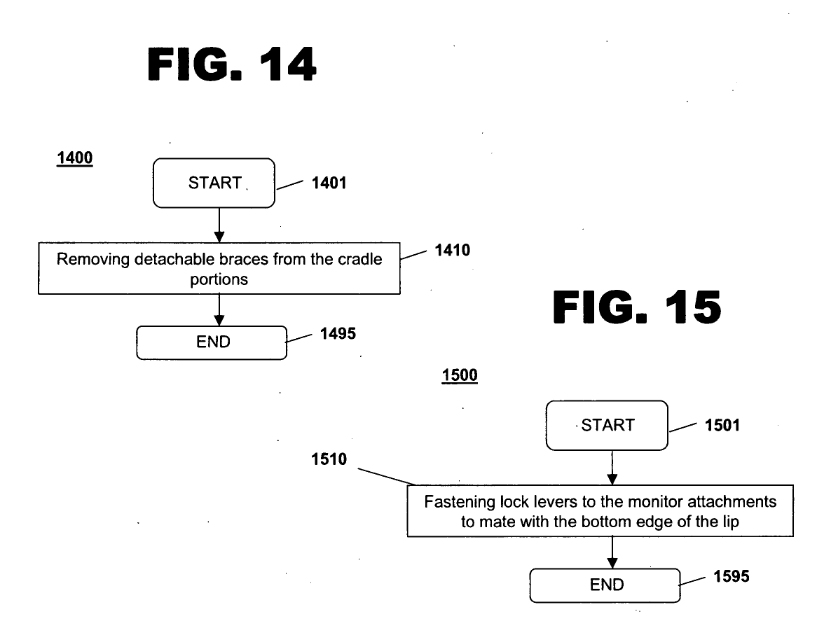

FIG. 14 illustrates one embodiment of a method 1400 for removing detachable braces 150, 151 from the wall mount cradle portions 180, 181, in accordance with one aspect of the invention. Method 1400 begins at 1401.

At step 1410, detachable brace 150 is removed from the top portion of first cradle 180. Also at step 1410, detachable brace 151 is removed from the top portion of second cradle 181. Method 1400 ends at step 1495.

FIG. 15 illustrates one embodiment of a method 1500 for fastening the lock levers to the monitor attachments to mate with the bottom edge of the mating lip, in accordance with one aspect of the invention. Method 1500 begins at 1501.

At step 1510, the first releasable lock lever 140 is fastened to the first monitor attachment 110 and the second releasable lock lever 141 is fastened to the second monitor attachment 111. Each lock lever 140, 141 mates to the bottom edge 177 of the wall mount lip 175. Method 1500 ends at step 1595.

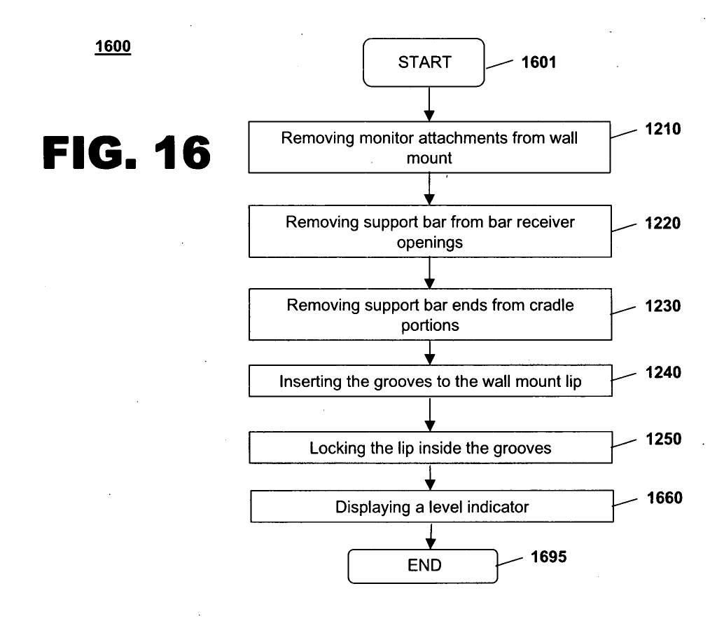

FIG. 16 illustrates one embodiment of a method 1600 for changing a video monitor mount configuration from an adjustable tilt angle to a fixed upright angle, in accordance with one aspect of the invention. Method 1600 begins at 1601.

In one embodiment, method 1600 executes method 1200. After executing method 1200, method 1600 displays a level indicator at step 1660. The level indicator is displayed using an appropriate level indicator, such as bubble level indicator 173.

Method 1600 ends at step 1695.

FIG. 17 illustrates a perspective view for an adjustable tilt angle configuration, in accordance with one aspect of the invention. Method 1700 begins at step 1701.

In one embodiment, the support bar 130 is inserted through bar receiver openings along the support bar axis 195 and is secured in the wall mount cradle portions 180, 181 by detachable braces 150, 151. Monitor attachments 110, 111 are separated by an adjustable distance 105. Grooves 116 and 117 are located above mating lip 175. The top 101 is located at the end of the vertical brace with the channel 118. The bottom 102 is located by the end of the vertical brace with the screw holes 122.

Method 1700 ends at step 1795.

FIG. 18 illustrates a side view for an adjustable tilt angle configuration in accordance with one aspect of the invention. In one embodiment, groove 116 is biased along axis 192 towards the top 101, above mating lip 175. In one embodiment, lip 175 includes a top edge 176 and a bottom edge 177. Detachable brace 150 is attached with screws or other appropriate fasteners to the cradle portion 180 and circumscribes support bar 130 around the circumference of support bar 130. In one embodiment, tilt knob 165 adjusts the tilt angle 167 (see FIG. 24). The tilt knob provides a rotation input to a tilt bar. The tilt bar 160 is operatively connected to the monitor attachment 110, 111 so the monitor attachments 110, 111 rotate when the tilt knob 165 rotates the tilt bar 160. The top 101 is located by the end of the vertical brace with the channel 118. The bottom 102 is located by the end of the vertical brace with the screw holes 122. The front 102 is the side of the wall mount with the level indicators. The back 104 is the side of the wall mount that attached to a wall.

FIG. 19 illustrates a side view for an adjustable tilt angle configuration in accordance with one aspect of the invention. FIG. 19 illustrates the various portions of the first monitor attachment 110. The monitor attachment 110 includes a vertical leg 112 defining a leg axis 190. Vertical leg 112 includes an upper portion 114 including a groove portion 196, the groove portion 196 including a groove 116, the groove 116 defining a groove axis 192 extending substantially parallel to the leg axis 190. Further in the adjustable tilt angle configuration, a radius 1910 between the support bar axis 195 and the groove 116 on the first monitor attachment 110 is constant, and a distance between the groove 116 and the mating lip 175 changes responsive to the tilt angle 167.

FIG. 20 illustrates a side view for an adjustable tilt angle configuration in accordance with one aspect of the invention. FIG. 20 illustrates the various portions of the second monitor attachment 111. The monitor attachment 111 includes a vertical leg 112 defining a leg axis 191, the vertical leg 112 including an upper portion 115 including a groove portion 197. Groove portion 197 includes a groove 117, the groove 117 defining a groove axis 193 extending substantially parallel to the leg axis 191. Further in the adjustable tilt angle configuration, a radius 1911 between the support bar axis 195 and the groove 117 on the second monitor attachment 111 is constant, and a distance between the groove 117 and the mating lip 175 changes responsive to the tilt angle 167. FIG. 20 shows a different embodiment of a monitor attachment than FIG. 19.

FIG. 21 illustrates a perspective view for a fixed upright angle configuration in accordance with one aspect of the invention. The support bar 130 is removed. The tilt knob 165 and tilt bar 160 are functionally inoperative. In one embodiment, the first monitor attachment groove 116 is mated to the mating lip 175. The second monitor attachment groove 117 is mated to the mating lip 175. Wall mount lip 175 obstructs rotational movement to the monitor attachments 110, 111. Lock lever 141 attaches as one embodiment of the lock lever device with screws attaching it to the first monitor attachment 110. The lock lever prevents an upward force from disjoining the monitor attachment from the mating lip 175. In one embodiment, the first monitor attachment 110 includes channel 118 and screw holes 122 for fastening to the back of a monitor. Channel 119 and screw holes 123 on the second monitor attachment 111 accommodate fastening to the back of a monitor.

FIG. 22 illustrates one embodiment for a locking lever for a fixed upright mount configuration in accordance with one aspect of the invention. One embodiment of a releasable lock lever includes an angled lock clip including a channel configured to mate with the bottom edge of the mating lip 175. Lock lever 141 wedges under the lower edge 177 of mating lip 175.

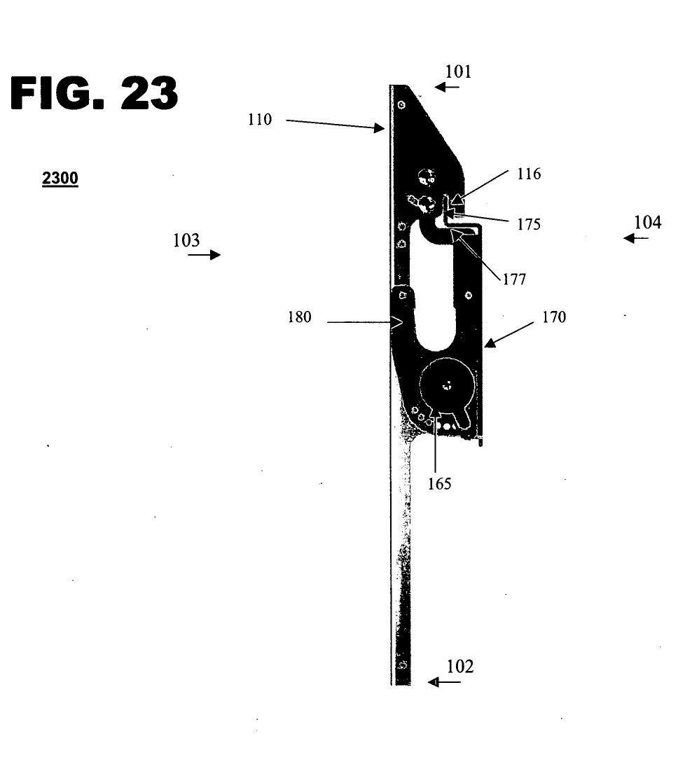

FIG. 23 illustrates a side view for a fixed upright angle positioning in accordance with one aspect of the invention. FIG. 23 illustrates the mating of the mating lip 175 to the monitor attachment groove 116. The mating connection prevents rotational movement along the support bar axis 195 of the monitor attachment. Therefore, the groove axis 192 (see FIG. 24) is fixed parallel to the lip plane 179 (see FIG. 24) and the tilt angle 167 (see FIG. 25) is approximately 0 degrees.

FIG. 24 illustrates a side view for an adjustable tilt angle configuration showing various axes and planes in accordance with one aspect of the invention. The wall mount includes a mating lip 175 defining a mating lip plane 179, the lip plane 179 defining a tilt angle 167. The tilt angle 167 is the angle between the lip plane 179 and the groove axis 192. The tilt angle 167 shown in FIG. 24 is approximately 0 degrees because the groove axis 192 is aligned substantially parallel to the lip plane 179. However, once the monitor attachment is tilted forward or backward by turning the tilt knob 165 clockwise or counter clockwise the tilt angle 179 will change from zero because the groove axis 192 will no longer be substantially parallel to the lip plane 179.

FIG. 25 illustrates a magnified side view for an adjustable tilt angle configuration showing the groove axis and lip plane in accordance with one aspect of the invention when the tilt angle 167 is approximately 0 degrees.

FIG. 26 illustrates a side view for an adjustable tilt angle configuration showing the groove axis and lip plane in accordance with one aspect of the invention when the tilt angle 167 is approximately 20 degrees. The monitor attachment is tilted forward, so the tilt angle 179 is greater than zero degrees because the groove axis 192 is not parallel to the lip plane 179.

Other variations and combinations of features will be apparent to those with skill in the art. Those variations are included within the disclosure herein.

What is claimed is:

1. A method for configuring a video monitor mount from a fixed upright angle to an adjustable tilt angle, the method comprising:
releasing a first monitor attachment and a second monitor attachment from a wall mount, the wall mount including a wall mount lip with a top edge and a bottom edge, the first monitor attachment including a first bar receiver opening and the second monitor attachment including a second bar receiver opening;
receiving a support bar in the first bar receiver opening and the second bar receiver opening, the support bar including a first end portion and a second end portion; and
receiving the first end portion and the second end portion of the support bar in a first cradle portion and second cradle portion of the wall mount.

2. The method of claim 1, wherein releasing a first monitor attachment and a second monitor attachment from the wall mount comprises:
releasing a first releasable lock lever from the first monitor attachment, the first lock lever attached to the first monitor attachment and mated to the bottom edge of the wall mount lip;
releasing a second releasable lock lever from the second monitor attachment, the second lock lever attached to the second monitor attachment and mated to the bottom edge of the wall mount lip; and
disengaging a groove of each the first monitor attachment and the second monitor attachment from the mating lip of the wall mount.

3. The method of claim 1, further comprising
receiving a first detachable brace in a top opening of the first cradle portion, wherein the brace and the cradle attached together circumscribes the first end portion of the support bar;
receiving a second detachable brace in a top opening of the second cradle portion, wherein the brace and the cradle attached together circumscribes the second end portion of the support bar.

4. The method of claim 1, further comprising:
receiving a rotation input via a tilt knob in communication with a tilt bar, the tilt bar operatively connected to the monitor attachment.

5. The method of claim 1, further comprising:
receiving a cord within a cord management strap.

6. The method of claim 1, further comprising displaying a level indicator, the level indicator displayed via at least one bubble level attached to the wall mount.

7. The method of claim 1, further comprising:
receiving a rotation input via a tilt knob in communication with a tilt bar, the tilt bar operatively connected to the monitor attachment.

8. A method for configuring a video monitor mount from an adjustable tilt angle to a fixed upright angle, the method comprising:
releasing a first monitor attachment and a second monitor attachment from a wall mount, the first monitor attachment including a first bar receiver opening and a mating groove and the second monitor attachment including a second bar receiver opening and a mating groove, the wall mount including a mating lip with a top edge and a bottom edge;
releasing a support bar from the first bar receiver opening and the second bar receiver opening, the support bar including a first end portion and a second end portion;
releasing the end portions of the support bar in a first and second cradle portion of the wall mount;
mating the groove of each first monitor attachment and the second monitor attachment to the mating lip of the wall mount; and
clasping the mating lip inside the groove of the first monitor attachment and second monitor attachment.

9. The method of claim 8, wherein releasing the first and second monitor attachments from a wall mount comprises:
releasing a first detachable brace from the top of the first cradle portion, wherein the brace and the cradle portion attached together circumscribes the first end portion of the support bar; and
releasing a second detachable brace from the top of the second cradle portion, wherein the brace and the cradle portion attached together circumscribes the second end portion of the support bar.

10. The method of claim 8, wherein clasping the mating lip inside the groove of each the first monitor attachment and second monitor attachment comprises:
attaching a first releasable lock lever to the first monitor attachment, the first lock lever mating to the bottom edge of the wall mount lip; and
attaching a second releasable lock lever to the second monitor attachment, the second lock lever mating to the bottom edge of the wall mount lip.

11. The method of claim 8 further comprising:
displaying a level indicator via at least one bubble level attached to the wall mount.

12. A method for configuring a video monitor mount, the method comprising:
removing a first monitor attachment and a second monitor attachment from a wall mount, the first monitor attachment including a first bar receiver opening and a mating groove and the second monitor attachment including a second bar receiver opening and a mating groove, the wall mount including a mating lip with a top edge and a bottom edge;
removing a support bar from the first bar receiver opening and the second bar receiver opening, the support bar including a first end portion and a second end portion;
removing the first end portion and second end portion of the support bar from a first cradle portion and second cradle portion of the wall mount;
inserting the groove of each the first monitor attachment and the second monitor attachment over the mating lip of the wall mount; and
locking the mating lip inside the groove of each the first monitor attachment and second monitor attachment.

13. The method of claim 12 further comprising:
inserting the support bar in the first bar receiver opening and second bar receiving opening.

14. The method of claim 12, wherein releasing the first and second monitor attachments from a the wall mount comprises:
removing a first detachable brace from the first cradle portion; and
removing a second detachable brace from the second cradle portion.

15. The method of claim 12 wherein locking the mating lip inside the first monitor attachment and second monitor attachment comprises:
fastening a first releasable lock lever to the first monitor attachment, the first lock lever mating to the bottom edge of the mating lip; and
fastening a second releasable lock lever to the second monitor attachment, the second lock lever mating to the bottom edge of the mating lip.

16. The method of claim 12 further comprising:
displaying a level indicator, the level indicator displayed via at least one bubble level attached to the wall mount.
